(19) United States
(12) Patent Application Publication
(10) Pub. No.: US 2002/0163504 A1
(43) Pub. Date: Nov. 7, 2002

(54) Hand-held device that supports fast text typing

(76) Inventor: Matthew G. Pallakoff, Mountain View, CA (US)

Correspondence Address: GARY CARY WARE & FREIDENRICH LLP, 1755 EMBARCADERO ROAD, PALO ALTO, CA, 94303-3340, US

(21) Appl. No.: 10/107,903

(22) Filed: Mar. 11, 2002

Related U.S. Application Data
(60) Provisional application No. 60/275,572, filed on Mar. 13, 2001.

(51) Int. Cl. G09G 5/00

(52) U.S. Cl. 345/169

(57) ABSTRACT

The invention comprises a hand-held device with multiple keys on its face (“face-keys”) and with one or more buttons on its side (“side-buttons”). A user types a character (or invokes a function) by pressing one of the face-keys using a finger on the hand that is not holding the device while simultaneously holding in combinations of the side-buttons with fingers on the hand that is holding the device. Pressing a face-key without holding in any of the side-keys produces a given character (or function). Pressing the same face-key while simultaneously holding in a given combination of the side-keys can result in a different character (or function). The invention allows for faster typing of text on cell phone handsets and other hand-held devices.

### BACKGROUND OF THE INVENTION

The invention generally relates to a hand-held electronic device. More specifically, the invention relates to a device that allows a person to type text quickly on hand-held electronic devices.

Typing on most cell phone handsets (and other hand-held devices) is slow and awkward. Yet the need to type text using hand-held devices is growing quickly, thanks largely to the emergence of wireless data services (such as GoAmerica and OmniSky in the United States, and NTT DoCoMo in Japan), the proliferation of “Internet-enabled” cell phone handsets and personal digital assistants (PDAs), and the growing popularity of mobile Internet-based services such as email, instant messaging, and Web-browsing.

Most cell phone handsets include a “Start call” button and an “End call” button. As with all other buttons described in this patent, the precise names, symbols or graphics on the buttons are for illustrative purposes and can vary without departing from the spirit or scope of the invention. When a user presses the “Start call” button, the cell phone handset behaves like any other phone: Pressing the face-keys with the numbers 0 through 9, “*” and “#”, generates the appropriate tones and dials the phone number. When finished with the call, the user will press the “End call” button or perhaps just turn the phone off using an on/off button.

However, many modern mobile devices allow users to do more than place phone calls: Many modern cell phone handsets (and other hand-held devices) allow users to enter and view personal information management data, such as addresses, check and answer email, send instant messages, or even browse the Web —among a growing list of features. When using these features, users will often find themselves in a context that calls for typing text.

Size is a key constraint in the design of hand-held devices, especially cell phone handsets. In general, the goal is to keep the device small. But current handset designs have not been very successful in facilitating text typing within the constraints of a small form-factor. For example, on today's cell phone handsets the alphabet is represented across the number keys. In most case, A, B and C are on the key labeled 2, D, E and F are on the 3 key, and so on. Many phones leave out Q and Z. Others put “PQRS” on the 7 key and “WXYZ” on the 9 key. Users type by pressing the number keys. On most cell phones today, to type the word “Baby” a user would type the 2 key twice quickly (because “B” is the second letter on the 2 key), pause for a second so as not to type the letter “C”, type the 2 key once (because the letter “A”is the first letter on the 2 key), pause for a second so as not to type the letter “B”, type the 2 key twice again (for the second “b” in Baby), then type the 9 key three times (because the letter “Y” is the third letter on the 9 key).

In another but still slow configuration, the phone may be programmed to automatically capitalize the first letter in a sentence and leave the others lowercase. Or the user may be able to determine capitalization by typing keys even more times: For example, typing the 2 key once may result in a lowercase “a”, twice results in a lowercase “b”, three times results in a lowercase “c”, four times results in an uppercase “A”, five times results in an uppercase “B”, six times in an uppercase “C”—and perhaps seven times results in a “2” (the number associated with that key). Further typing on that key will typically loop around and start over on lowercase letter “a”. This is also prone to error. For example, to type a given letter twice, the user must type the letter once, pause (so the hand-set knows the user isn't just cycling past that letter on the key being pressed) and then type that letter again. For example, to type the letter “I” twice (for example, when typing the word “hello”), the user would press the 5 key three times (since “I” is the third letter on that key), pause, and then press the 5 key three more times (to type the second “I”). Pressing the 5 key six times (without pausing) would type the capital letter “L” once on a typical current handset, rather than typing the lowercase letter “I” twice.

Some phones and phone-accessible applications (such as E*Trade's phone-based stock-trading service) use a different, equally awkward typing scheme: A user who wants to type the letter J would type the number key 5 (which has the letters J K and L) followed by the number 1 (because J is the first letter on that key). To type the letter K, a user would type the 5 key followed by the number 2 (because K is the second letter on the 5 key). And to type the letter L, the user would type the 5 key followed by the number 3 (because L is the third letter on the 5 key).

Typing with either of the schemes outlined above is awkward and slow. Also, the system must either guess the capitalization of each letter (e.g. capitalize the first letter of the first word in each sentence, make the rest lowercase), or require the user to use additional keystrokes to convert a given letter into an upper case letter. Both schemes make it nearly impossible for a person to develop the sort of hand-eye, mind-eye, and muscle coordination that allow for fast typing.

Other telephone handset typing schemes allow users to type letters and numbers by holding multiple handset face-keys down simultaneously. U.S. Pat. No. 6,184,803 and U.S. Pat. No. 6,043,761, both incorporated herein by reference, describe two examples. These schemes can allow for quicker typing by letting users type each character with one event—simultaneously holding two face keys down. But they require considerable dexterity by the user. For example, typing the letter “C” can require that the user type the 2 key and the # key at the same time. Since many users will find this difficult to learn and use, these handset typing schemes also allow a user to revert to sequential typing—e.g. typing the 2 key followed by the # key. The schemes covered in these two patents also require users to either type in all lower case, all upper case, or in a mode that requires an additional keystroke to capitalize a letter. In other words, typing mixed upper and lower case letters requires the user to revert to a multi-keys-per-letter typing style—which makes typing slower and more awkward than it would be if every key, upper and lower case, could be typed with a single event.

One software developer for mobile devices, Tegic Communications (www. t9. com), has developed software for cell phones that uses dictionaries and algorithms to allow people to type most words by typing just one key per letter. With Tegic's T9 Text Input software, if a user types the sequence of cell phone handset keys imprinted with the letters “h-o-m-e” (which are the keys 4-6-6-3 on most cell phone handsets today), then Tegic's software identifies all words that could correspond to that key sequence (there could be more than once since each key corresponds to three letters), shows one of those words, and allows the user to accept it or scroll through the alternatives if Tegic's software chose the wrong word. As the user types a word, the software shows a match for the keys typed so far. Since most of the keys contain three letters (such as A, B and C on the 2 key; D, E, and F on the 3 key, etc.), a sequence of key presses can correspond to several different words in Tegic's Software's dictionaries.

For example, suppose a user types “home”: When the user types the 4 key (corresponding to the letter “h”), Tegic's software shows “i” (which is also on the 4 key). When the user types the 6 key (corresponding to the second letter in the word “home”, “o”) then Tegic's software shows “in” (since “n” is also on the 6 key). When the user types the 6 key again (corresponding to the third letter in “home”, “m”) then Tegic's software shows “inn”. When the user types the key 3 (corresponding to the final letter in the word “home”, “e”) then Tegic's software changes what it has shown so far from “inn” to “good”—the first word in its dictionaries that matches the keys pressed so far. Like the word “home”, the word “good” happens also to correspond to the keys 4-6-6-3 on most telephone handsets. Since “good” isn't the word the user wanted to type (which was “home”), Tegic's software allows users to scroll through other matches using an appropriate button on the cell phone (such as the 0 key at the bottom center on most handsets). When the user types this “next word” button, Tegic's software shows the next word in its dictionary corresponding to the keys that were hit. In this example, the next word is likely to be “home”. So the user can hit the 0 key once to switch the word “good” to the word “home”. In this example, the user had to press five keys to type the word “home”: 4-6-6-3-0. In many cases, the first word presented by Tegic will be the correct word (because that will be the first word Tegic finds in its dictionary corresponding to the sequence of keys hit). In other cases, the user may have to hit the “next-word” button several times to get to the right word in the dictionary. In still other cases, the word the user wants to type will not be in the dictionary at all. So Tegic's software often allows users to type words with fewer keystrokes than the multi-key-presses-per-letter schemes outlined earlier. In many cases, the user can type one key per letter, and Tegic's software will come up with the correct word. But Tegic's approach has several drawbacks. First, if a word is not in the dictionaries used by Tegic's software (which will often be the case for proper nouns and acronyms, such as company names for example), then the word will not be successfully typed by Tegic's software—either as the first choice presented or as any of the alternatives. In this case, the user has to revert to one of the multi-keys-per-letter schemes outlined earlier. Second, as a user is part way through typing a word, Tegic's software will often display a different partial word than the one that has been typed. For example, as noted earlier, after typing the first three keys for the word “home”—the user will see the characters “inn” on the display, instead of seeing “hom”. Similarly, after typing the first three letters of the word “meeting”, the user will see “off” on the display. This can be confusing for users—especially since typing on today's cell phone keypads is a fairly new and slow process for most users, so they need visual confirmation of their progress. If a user looks up and sees “off” when they thought they were half way through typing the word “meeting“, the typical reaction is to want to use the backspace key to erase the apparent typo. (This is why Tegic's documentation instructs users to “ignore what's on the screen until you've typed the word completely”.) A third issue with Tegic's software is that it uses dictionaries and lookup software, which can consume precious memory and CPU time on low-cost and low-power mobile devices. A dictionary with 50,000 words would typically consume 150-300 kilobytes of memory.

Some new hand-held device designs allow users to type using their thumbs or index fingers on a tiny, so-called “Qwerty,” keyboard—tiny versions of the keyboards used with most desktop computers. An example of such a device with a tiny Qwerty keyboard is seen in U.S. Pat. No. 6,278,442 B1 incorporated herein by reference. But a Qwerty keyboard on a cell phone looks strange to most cell phone consumers today—limiting the percentage of potential cell phone customers who would consider buying a cell phone with a Qwerty keyboard. And even the smallest thumb-Qwerty keyboards that most people can comfortably type are wider than most cell phones sold today—so they require non-standard cell phone form-factors.

Other hand-held devices use character recognition software to allow users to draw letters on touch-pads using a stylus or a finger. While some of these input schemes are significantly easier and faster to use than the multiple-key-presses-per-letter cell phone typing schemes discussed earlier, they are still significantly slower to use than computer keyboards, at least for experienced typists.

In short, there is a growing need for new cell phone handset designs (and, more generally, hand-held device designs) that allow users to type text faster, while keeping the device small.

### SUMMARY OF INVENTION

The most general form of the present invention is a hand-held device with multiple keys on its face (hereafter called “face-keys”) and with one or more buttons on its side (hereafter called “side-buttons” or “modifier buttons”). A user types a character (or invokes a function) by pressing one of the face-keys using a finger on the hand that is not holding the device while simultaneously holding in combinations of the side-buttons with fingers on the hand holding the device. Pressing a face-key without holding in any of the side-keys types one character (or performs a function). Pressing the same face-key while simultaneously holding in a given combination of side-keys can type a different character (or perform a different function).

The present invention allows users to type quickly on hand-held devices—particularly cell phone handsets. Many other types of devices can use this same input mechanism including PDAs, hand-held computers, smart-phones, Web-phones, pagers, instant-messaging devices, input-devices connected to field equipment, and so on. The invention can be implemented on cell phone handsets while retaining traditional cell phone form-factors (as well as non-standard form-factors). The invention is easy and intuitive for beginners to learn and use—so they can immediately type fairly quickly. Further, the invention enables motivated users to learn to type very quickly—by developing the sort of “mind-hand” coordination and muscle-memory that lets fast touch-typists type quickly on regular computer keyboards and lets check-out clerks operate 10-key number pads very quickly at supermarket checkout stands.

### DESCRIPTION OF PREFERRED EMBODIMENTS

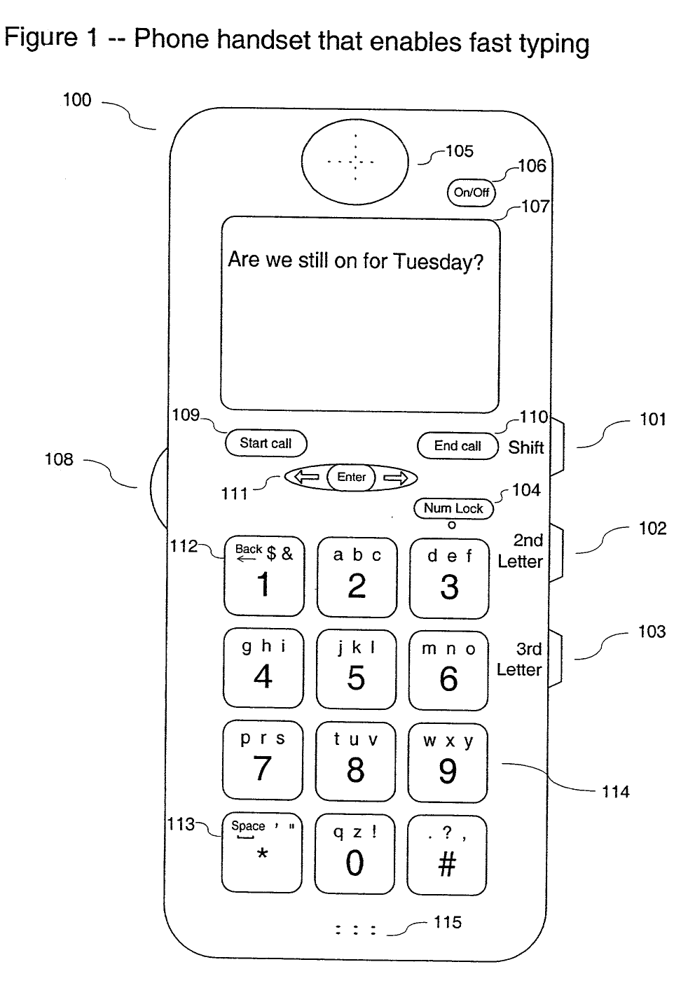

The first preferred embodiment of the present invention adds three new buttons to the side of a typical cell phone handset, as shown in FIG. 1. Although FIG. 1 is drawn showing a display, it is not necessary that there actually be a display, depending on the requirements of the hand-held device implementing my invention. For example, my invention could easily be implemented in a hand-held device that does not require a display. The three new side-buttons seen in FIG. 1 are a “Shift” side-button 101, a “2nd Letter” side-button 102, and a “3rd Letter” side-button 103. In contexts where the phone is being used to type text, a user would hold the handset depicted in FIG. 1 in the left hand and use that hand's index, middle, and ring fingers to hold in combinations of the “Shift”, “2nd Letter”, and “3rd Letter” side-buttons, respectively, while simultaneously using the right hand to press keys on the face of the handset.

If none of the side-buttons are held in, then pressing one of the face keys simply types the first letter on that key. For example, pressing the “2” key on the handset in FIG. 1 results in a character which is the lowercase letter “a” being typed in contexts where the phone is being used to type text. To type a character that is an uppercase version of the first letter on a given face-key (such as the uppercase letter “A”), the user holds in the “Shift” side-button 101 while pressing that face-key. So the “Shift” side-button 101 behaves like it does on a regular computer keyboard, modifying the behavior of other keys. The “Shift” and “Ctrl” keys, on many regular computer keyboards are sometimes called “modifier”, keys. The side-buttons discussed in this invention description are modifier buttons in that, when held in, they modify the behavior of the device's face-keys. To type a lowercase version of the second letter on a given face-key (such as the letter “b” on the “2” key), the user holds in the “2nd Letter” side-button 102 while simultaneously pressing that face-key. To type an uppercase version of the 2nd letter on a given face-key (such as the uppercase letter “B”), the user holds in both the “Shift” side-button 101 and the “2nd Letter” side-button 102 while pressing that face-key.

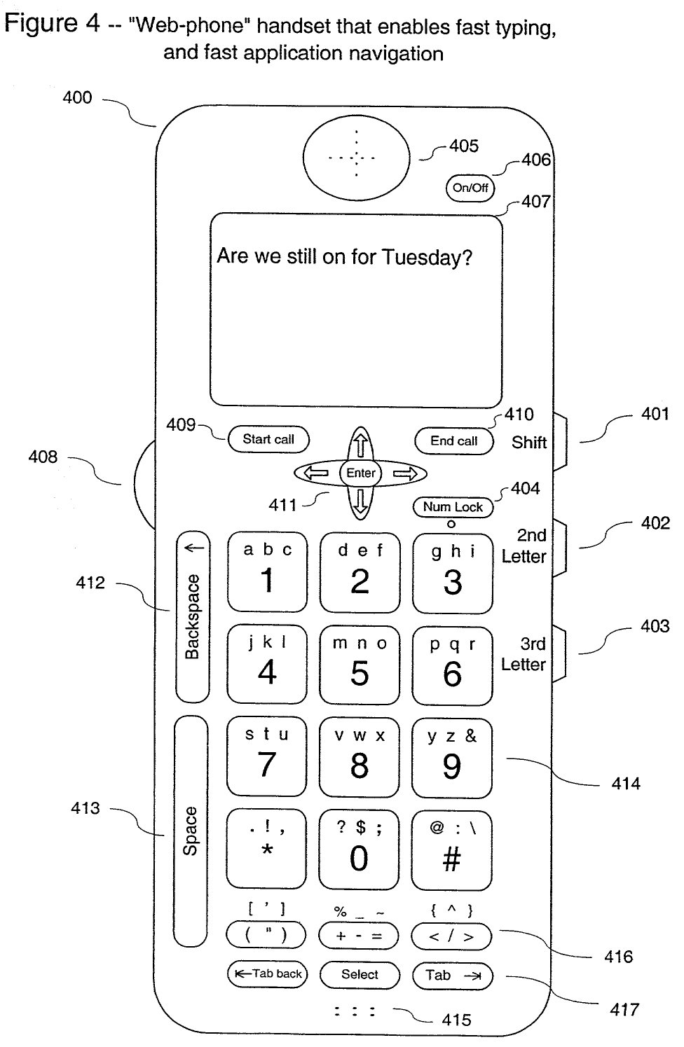

To type a lowercase version of the 3rd letter on a given face-key (such as the letter “c” on the “2” key), the user holds in the “3rd Letter” side-button 103 while simultaneously pressing that face-key. To type an uppercase version of the 3rd letter on a given face-key (such as the uppercase letter “C”), the user holds in both the “Shift” side-button 101 and the “3rd Letter” side-button 103 while pressing that face-key. All references to letters and keys in this example refer to the sample layout illustrated in FIG. 1. Handsets can also be designed with letters positioned on different keys, as we will see below when we discuss FIG. 4.

Some people may find it slightly awkward to simultaneously press the Shift side-button and the “3^{rd} Letter” side-button without also pressing the “2^{nd} Letter” side-button -between them (see FIG. 1). So one preferred embodiment of a device (and the device's software processes and storage systems) could interpret simultaneous pressing of all three side buttons (“Shift”, “2^{nd} Letter”, and “3^{rd} Letter”) the same as simultaneous pressing of just the Shift and “3^{rd} Letter” side-buttons. Or an embodiment could simply ignore the “2^{nd} Letter” button when the “3^{rd} Letter” button is being pressed.

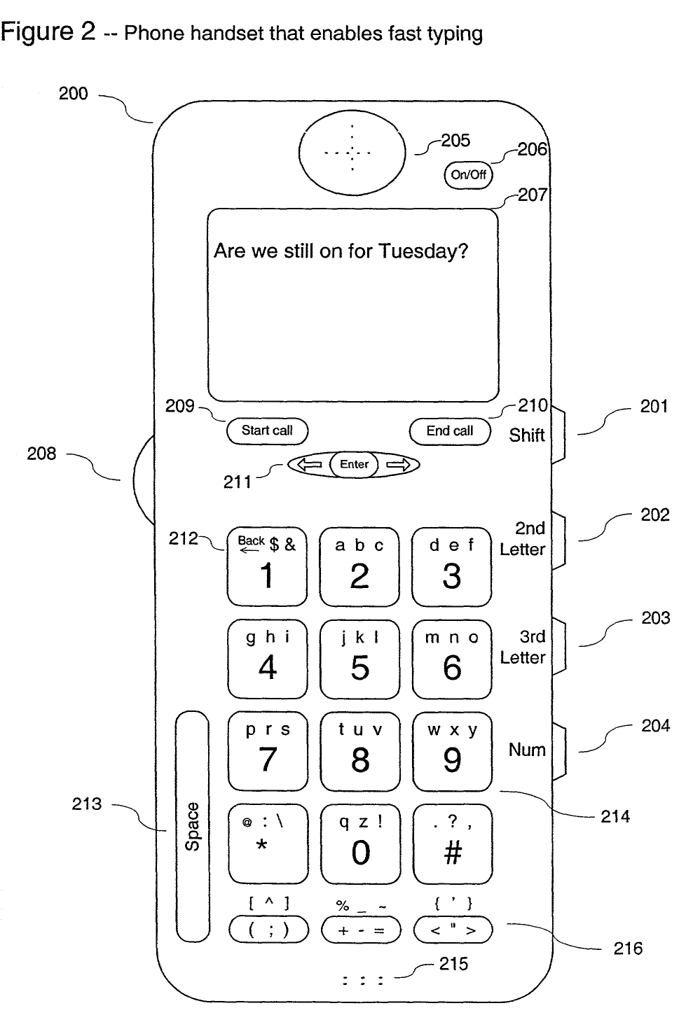

The entire alphabet, plus some common punctuation, a space character, and backspace character (which behaves like the backspace key on a computer keyboard) should appear on a handset made for typing. FIG. 1 shows an example. FIG. 2, 3, and 4 show other examples and are discussed in detail subsequently.

Sometimes users need to type numbers while in a text-typing context—for example, to enter a street address in their personal information management database. FIG. 1 shows a handset with a “Num Lock” face-button 104. When the user presses the “Num Lock” button once then the phone enters a mode in which the face-keys behave similarly to a the number keypad on many computer keyboards: When in the number-lock mode, pressing a given face-key simply types the main number or symbol on the face-keys (1, 2, 3, 4, 5, 6, 7, 8, 9, 0, *, or #). This number lock mode can be indicated by an LED just below the “Num Lock” button, shown as a tiny circle on FIG. 1 below the “Num Lock” button 104. When the user presses the “Num Lock” face-button 104 again, the phone exits the number-lock mode and returns to the non-numeric typing mode described earlier, and the Num Lock LED light would turn off.

The software necessary to implement the foregoing embodiment can be easily written by one of ordinary skill in the art from the foregoing teachings. An example of this follows. Each modifier button and each face key of the device could be implemented as a simple switch. As is well known, a hardware switch's contact is either open or closed at any given time. When a user presses any given button or key (e.g. closes the corresponding switch's contact), then firmware on the device sends a unique code corresponding to that button or key being pressed, such as a unique number or character, to a queue to be read by software running on the device. And when a user releases that button or key (e.g. opens the corresponding switch's contact), then the firmware on the device sends a unique code corresponding to that button or key being released to the queue. When a user presses a key a single time, the switch's contact often briefly closes and opens multiple times—i.e. it “bounces”. This can also happen when the user releases the key. So firmware developers commonly develop firmware that “debounces” key presses and releases. The firmware tracks whether multiple contacts are made in a very short period of time—such as 1/50^{th} of a second (or some other brief period) and, if so, treats them as a single press or release (depending on what state the switch was in and what state it winds up in.

Software on the device continuously looks for new codes to appear in the queue mentioned above—codes supplied by the firmware. The software reads those codes and proceeds to interpret them as typing. This interpretation software could also be implemented as part of the device's “firmware,” or it could be written to run on a processor that also runs a high level operating system such as Pocket PC or Linux. The pseudo code below describes one software procedure for interpreting the codes generated when the user operates buttons and keys on a device like the one shown in FIG. 1.

// Codes that firmware sends to queue as device keys and buttons are pressed

// Codes corresponding to Modifier buttons in FIG. 1 phone illustration

#define kShiftDown=1; // shift modifier button pressed

#define kShiftUp=2; // shift modifier button released

#define k2ndLetterDown=3; // 2^{nd} letter button pressed

#define k2ndLetterUp=4; // 3^{rd} letter button released

#define k3rdLetterDown=5; // 3^{rd} letter button pressed

#define k3rdLetterUp=6; // 3rd letter button released

// Codes corresponding to 12-keys in FIG. 1 phone illustration

// Note that the Down codes are even and the Up codes are odd in this example

#define k1KeyDown=10; // 1 key pressed

#define k1KeyUp=11; // 1 key released

#define k2KeyDown=12; // 2 key pressed

#define k2KeyUp=13; // 2 key released

#define k3KeyDown=14; // 3 key pressed

#define k3KeyUp=15; // 3 key released

#define k4KeyDown=16; // 4 key pressed

#define k4KeyUp=17; // 4 key released

#define k5KeyDown=18; // 5 key pressed

#define k5KeyUp=19; // 5 key released

#define k6KeyDown=20; // 6 key pressed

#define k6KeyUp=21; // 6 key released

#define k7KeyDown=22; // 7 key pressed

#define k7KeyUp=23; // 7 key released

#define k8KeyDown=24; // 8 key pressed

#define k8KeyUp=25; // 8 key released

#define k9KeyDown=26; // 9 key pressed

#define k9KeyUp=27; // 9 key released

#define kStarKeyDown=28; // * key pressed

#define kStarKeyUp=29; // * key released

#define k0KeyDown=30; // 0 key pressed

#define k0KeyUp=31; // 0 key released

#define kPoundKeyDown=32; // # key pressed

#define kPoundKeyUp=33; // # key released

#define kMinTypingKey=k1KeyDown;

#define kMaxTypingKey=kPoundKeyUp;

#define kNumLockDown=40; // Num Lock key pressed

#define kNumLockUp=41; // Num Lock key pressed

// Assume that there is a queue—such as a serial port queue—where

// the firmware writes one of the above codes whenever a user presses or releases

// one of the modifier buttons or face keys in the device shown in FIG. 1.

IntegerQueue Q; // define queue for the integer codes used in this pseudocode

// in various contexts, the device should interpret key and button presses

// as typing—for example, to let the user type email or instant messages

int code=0;

boolean gShift=false;

boolean g2ndLetter=false;

boolean g3rdLefter=false;

boolean gNumLock=false;

char charToType=null;

while (in-typing-context) {

charToType=null;

code=ReadFromQueue(Q); // fetch the next code from Queue

// set shift, 2^{nd} letter, and 3^{rd} letter variables according to most recent

// press or release of corresponding modifier button

if (code==kShiftDown) gShift=true;

else if (code==kShiftUp) gshift=false;

else if (code==k2ndLetterDown) g2ndLetter=true;

else if (code==k2ndLetterUp) g2ndLetter=false;

else if (code==k3rdLetterDown) g3rdLetter=true;

else if (code==k3rdLetterUp) g3rdLetter=false;

// Toggle state of Num Lock variable whenever the corresponding Num Lock

// key is pressed. Ignore releases of that key. (Other embodiments could use

// a separate Num modifier button instead of a NumLock key.)

else if (code==kNumLockDown) gNumLock=not gNumLock;

// If none of the modifier buttons or Num Lock key were pressed,

// maybe it a face key was typed that needs to be interpreted as

// a character, accounting for the modifiers and Num Lock state.

// In this particular example, the 1 key is a little different than most of the

// character keys, because the shift key is ignored for the 1 key . . .

// else if (code==k1KeyDown) {// user pressed 1 key

if (gNumLock) charToType=“1”; // if NumLock is down, we'll type number

else if (g3rdLetter) // else if 3^{rd} letter modifier button is being held

charToType=“&”; // we'll type 3^{rd} character on the 1 key

else if (g2ndLetter) // else if 2^{nd} letter modifier button is being held

charToType=“$”; // we'll type 2^{nd} character on the 1 key

else charToType=BackSpaceKey; // else we'll type 1^{st} character on 1 key

♥

// Te 2 key is typical of most of the character keys . . .

else if (code==k2KeyDown) {// user pressed 2 key

if (gNumLock) charToType=“2”; // if NumLock is down, we'll type number

else if (g3rdLetter) {// else if 3^{rd} letter modifier button down

if (gshift) charToType=“C”; // 3^{rd} character on the 2 key, capitalized

else charToType=“c”; // 3^{rd} character on the 2 key, not capitalized

// Note: It's fine to ignore the “2^{nd} letter” modifier button if the user

// is holding the “3^{rd} letter” modifier button. That lets user type “C” by holding

// “shift”, “2^{nd} letter”, and “3^{rd} letter” buttons simultaneously, while typing the

// 2 key—which is a little easier for some people than typing just the “shift”

// and “3^{rd} letter” buttons with the hand holding the phone.

}

else if (g2ndLetter) {// else if 2^{nd} letter modifier button is down

if (gshift) charToType=“B”; // 2^{nd} character on the 2 key, capitalized

else charToType=“b”; // 2^{nd} character on the 2 key, not capitalized

}

else {// else user is typing 1^{st} letter on 2 key

if (gshift) charToType=“A”; // 1^{st} character on the 2 key, capitalized

else charToType=“a”; // 1^{st} character on the 2 key, not capitalized

}

}

// The 3 key is similar to the 2 key . . .

else if (code==k3KeyDown){// user pressed 3 key

if (gNumLock) charToType=“3”; // if NumLock is down, we'll type number

else if (g3rdLetter) { // else if 3rd letter modifier button down

if (gshift) charToType=“F”; // 3^{rd} character on the 3 key, capitalized

else charToType=“f”; // 3^{rd} character on the 3 key, not

capitalized

}

else if (g2ndLetter) {// else if 2^{nd} letter modifier button is down

if (gshift) charToType=“E”; // 2^{nd} character on the 3 key, capitalized

else charToType=“e”; // 2^{nd} character on the 3 key, not capitalized

}

else {// else user is typing 1^{st} letter on 3key

if (gshift) charToType=“D”; // 1^{st} character on the 3 key, capitalized

else charToType=“d”; // 1^{st} character on the 3 key, not

capitalized

}

} .

.

.

// The other keys would be interpreted much like the 2 and 3 keys above.

// Characters like the punctuation on the # key can be processed much like

// the “$” and “&” characters on the 1 key were processed above—i.e. they

// aren't affected by the shift key. (Of course, a developer might choose to

// have different characters generated when the shift modifier is held.)

.

.

.

// if there's a character to type after all that processing, type it.

// We'll just call a routine here that proceeds to type the character,

// i.e. to display it and/or add it to a text buffer, as occurs when

// a user types on a regular computer keyboard.

// if (charToType !=null) Type(charToType);

}// end of main loop

// end of pseudo-code example

Reasonably skilled programmers can develop many other ways to implement software that interprets the keys and modifier buttons in accordance with this invention including—implementations that use lookup tables to make the software more scalable and more efficient than the above pseudo code (as discussed below), and implementations that interpret additional useful functions (such as auto-typing a character if a user presses and holds a given combination of keys and buttons for longer than some minimal amount of time, similar to the auto-type feature found on most desktop computers). Other embodiments could take into account additional character keys or additional modifier keys (such as those that appear on FIGS. 2, 3, and 4). And still other embodiments could take into account additional controls (such as a cursor control) or other i/o capabilities on the device—perhaps modifying the behavior of those controls or i/o elements depending on which combination of modifier keys are being held when those controls or i/o elements are operated by the user or the device.

The pseudo-code above uses “if-then” statements to interpret codes read from the queue—codes corresponding to the particular keys and buttons the user has pressed. As mentioned above, another way to interpret the codes is to use a lookup table. For example, in the above pseudo code, the interpretation section between:

if (code==k3rdLetterDown) gNumLock=not gNumLock;

and

if (charToType !=null) Type(charToType);.

could be replaced with code that uses a lookup table, similar to the following:

// If we've read a code representing one of the main keys being pressed down . . .

// (in our examples Down codes are even)

else if (Even(code) and (code >=kMinTypingKey) and (code <=

kMaxTypingKey) {

// Construct index for table lookup

// index=code * 8;

if (gShift) index=index +1;

if (g2ndLetter) index=index +2;

if (g3rdLetter) index=index +4;

// Lookup the character to type in our table

// charToType=CharTable[index];

}

In this example, the table CharTable, would have been set up by the code before entering the main loop. The table has one record for each of the main typing keys and eight entries for each record—one entry for each possible combination of the boolean variables gShift, g2ndLetter, and g3rdLetter. Each record entry contains the character that should be typed if the user presses the key corresponding to that record while simultaneously pressing the combination of Shift, 2^{nd}-letter, and 3^{rd}-letter side modifier buttons corresponding to that entry (as indicated in the code sample above).

Note that a device's software can change the interpretation of the pressing and releasing of keys, modifier buttons and controls based on context. For example, if a person is currently typing a dollar figure into a field on a web-based form that should only contain a dollar figure, and if the device's software is smart enough to know that the field should only contain a dollar figure, then the device's software can interpret the behavior of the modifier buttons in a way that makes it easier for the person to type dollar figures containing numbers, a dollar sign, a decimal point, and a comma (i.e. to make it easy to type figures such as “$3,581.52” into that field). This could include interpreting any press of a key containing a number so that it only types that number, regardless of the state of the modifier buttons or Num Lock (while typing proceeds in that field). Later, when the person wants to type email or a text message (for example) the device's software would pay attention to the modifier buttons.

In the pseudo-code example above, this context-sensitive interpretation of the typing of keys and buttons can be implemented simply by having a different lookup table for each context. For example, if there were three different contexts, each with its own corresponding interpretation of the typing of keys and buttons, we would change the line:

charToType=CharTable[index];

in the pseudo-code above to:

if (gcontext==k1stContext) charToType=CharTable1[index];

else if (gcontext==k2ndContext) charToType=CharTable2[index];

else if (gcontext==k3rdContext) charToType=CharTable3[index];

where CharTable1, CharTable2, and CharTable3 would have been set up before the main loop in a similar way as CharTable was set up in the earlier pseudo-code, and where gcontext is a variable tracking which context we're in (which could be altered by other parts of the code).

Another example of changing the interpretation of the keys and buttons based on context would be allowing the user to put a cell phone device that uses this invention into a traditional cell-phone multi-keys-per-letter typing mode when they want to type using one hand (i.e. without using the side modifier buttons): In that mode, the side modifier buttons would be ignored, and the user would have to press a key multiple times to type the second or third characters on the key and to distinguish between upper and lower case letters—as is required with many standard cell phones. Device makers who implement devices with multiple typing modes, as in this example, should implement user interfaces that allow users easily to switch between the modes (i.e. between the two-handed typing mode illustrated in the pseudo-code example above and traditional one-handed typing modes available on other phones today) ideally through an easily accessed software menu option, or via a physical button or switch on the device.

As one more example of changing the interpretation of keys and buttons to fit the context, one preferred embodiment of a cell phone employing these inventions would simply ignore the side modifier keys when the software knows the user is simply typing a phone number to begin a phone call (for example, right after the user pushes a “begin-call” button on the phone): In a phone-number-dialing context, the device can interpret the face keys as simple dialing buttons, as on any standard phone. The side-modifier keys could come into play when the device switches to a context where the user can type text and symbols—such as email, text messaging, or filling out fields on a Web page (among other possible contexts).

An alternative to the “Num-Lock” face-button of FIG. 1 is illustrated in FIG. 2, which shows an optional “Num” side-button 204. With this configuration, to type a number, or the symbols “*” or “#”, shown on a face-key, the user can hold in the “Num” side-button 204 with the pinky on the hand holding the phone, while typing that face-key with the other hand. In effect, the “Num” side-button behaves as a “4th Letter” button, similar to the “3rd Letter” button described above, allowing users to type the fourth character associated with each face-key, which is simply the number, or * or # symbol, corresponding to that key.

The invention includes designs having a “Num-Lock” face-button and designs having a “Num”0 side-button. The “Num-Lock” face-button approach requires more keystrokes when typing numbers. The “Num” side-button approach can result in slightly faster typing of text that includes numbers but it results in four side-buttons (as illustrated in FIG. 2), which looks a bit more cluttered. Both approaches are easy to learn and use.

To type the first letter associated with a face-key using the preferred embodiment of FIG. 1, a user presses that face-key. To type the second letter associated with a face-key, a user holds in the “2nd Letter” side-button 102 while pressing that face-key. To type the third letter associated with a face-key, a user holds in the “3rd Letter” side-button while pressing that face-key. Any letter typed will be lowercase unless the “Shift” side-button is held in too, in which case the letter will be uppercase. To type the number or symbol (0-9 or “*” or “#”) associated with a face-key, a user presses the “Num Lock” button 104 to enter the number-lock mode, types the face-key corresponding to that number or symbol, and (after typing any other numbers or * or # symbols desired) presses the “Num Lock” button again to exit the number-lock mode. If a handset design incorporates a “Num” side-button (as in FIG. 2) instead of a “Num Lock” face-button (as in FIG. 1), then to type the number or symbol associated with a face-key (0-9 or * or #), a user holds in the “Num” side-button while typing that face-key.

When a person holds a handset (or other device) based on the embodiment of FIG. 1 or FIG. 2, and the person is given the instructions outlined in the previous paragraph, it becomes fairly easy for that person to immediately type text using that handset. A new user can type full, correctly punctuated sentences fairly quickly on such a handset relative to other cell phone handsets, even if the user uses just one finger to type the face keys.

With this embodiment, motivated users can learn to type very quickly, relative to other cell phone handset designs. They can do this by learning to type the face-keys using three fingers instead of one: On the phone illustrated in FIG. 1, the user would use the index finger for the left column of keys (keys “1”, “4”, “7”, and “*” in FIG. 1), using the middle finger for the middle column of keys (keys “2”, “5”, “8”, and “0”), and using the ring finger for the third column of keys (keys “3”, “6”, “9” and “#”). If a phone were designed for holding in the right hand and pressing keys with the left hand, the user would use the ring finger for the left column, the middle finger for the middle column, and the index finger for the right column. Experienced super-market checkout-stand workers (and accountants) learn to enter numbers very quickly on adding-machine keypads by using three fingers—a different finger for each column of numbers. Similarly, experienced users of this invention can learn to type full text very quickly by holding the handset in one hand, using three fingers on the other hand to type face-keys (a different finger for each column of face-keys), while using the “Shift”, “2nd Letter” and “3rd Letter” side-buttons (with fingers on the hand holding the handset) to determine which character on each face-key should be generated at any given moment. A person who practices and gains experience with this technique will be able to develop the kind of muscle-memory and mind-eye coordination that allows many people to type very quickly on computer keyboards or adding machines. Users will probably not learn to type as quickly on a cell phone handset of this invention as they can on computer keyboards. But many users are likely to learn to type much faster on a handset designed according to this embodiment than they could on previous cell phone handset designs.

With this embodiment, users will typically type using two hands—one holding the phone and operating the side-buttons, and the other typing the face-keys. If the hand-set designer wants to enable the user also to type text with the same hand holding the handset—for fully one-handed operation—he or she could design the phone so that the user can use a thumb-wheel [sometimes called a jog dial] or other types of controls, side-buttons or face-keys, to put the phone in a multiple-keys-per-character mode. In this mode, the handset would operate like most of today's cell phone handsets, requiring multiple key presses per character while allowing users to type using the face-keys only. However, it is not necessary to include this extra mode: Most users simply do not type text on cell phone handsets with one hand, even if it is theoretically possible on some of today's handsets, because it is too difficult and awkward. One could support one-handed users with this feature, if that were a priority. However, the handset design should make it easy for a user to hold the handset in one hand, while driving or holding a briefcase in the other hand, and to use a thumb-wheel or other control with the thumb or fingers on the phone holding the handset to quickly scroll through functions and data stored in the handset. For example, a user should be able to scroll through their contacts, or some subset of them, and initiate a phone call or voice-message to any of those contacts—using just one hand. Many modern cell phone handsets solve this problem fairly well.

The most common character in the text of many languages is the Space character, so it should be especially easy to type a space on handsets designed for those languages. FIG. 1 shows a “space” character as the first character on the “*” face-key 113 at the lower left of the handset. When in a context in which typing is required, a user can type a space simply by typing the “*” face-key, without holding in any of the side-buttons, since the space character is the first character on the “*” key. FIG. 2 shows an alternative configuration in which the space key 213 is separated into a large space bar on the left side of the phone—making it even easier for users to type the space key. This is analogous to the large space bar on most computer keyboards. Extra speed can be gained by separating the space-key into its own large face-key 213 as shown in FIG. 2. If the space-key is separated into its own large face-key 213 to the side of the other columns of face-keys, then a user can use his or her thumb to type spaces while using their right index, middle, and ring fingers to type the other characters as described above. Similarly, separating the backspace key into its own separate large face-key 412, as shown in FIG. 4, can allow users to edit text and correct mistakes more quickly. The cost of separating the space key and the backspace key into separate large face-keys is size: The phone becomes a little wider than it would be without those separate keys. But the extra speed gained could allow users to become quite a bit more comfortable (and speedy) when typing text on hand-held devices. Also, separating the space and backspace keys into their own face-keys frees up positions on the main columns of face-keys, which allows for additional symbols. For example, FIG. 4 shows a highly functional, easy-to-learn, easy-to-use and nicely symmetrical character layout enabled by moving the space and backspace keys to large separate face-keys.

The handset designer can adjust the exact order and position of the device's side-buttons. Users can choose to use other fingers than those described previously in this paragraph to operate those side-buttons. Handsets can also be designed to be held in the right hand—in which case these side-buttons would be positioned on the left side of the handset where a user could operate them with the fingers of the right hand. Or handsets can be designed with the modifier buttons on both sides of the handset—a set of Shift, 2^{nd} Letter, and 3^{rd} Letter modifier buttons on the left side; and a mirror set of Shift, 2^{nd} Letter, and 3^{rd} Letter modifier buttons on the right side. Pressing the side-buttons and face-buttons does not require much dexterity or hand-eye coordination—certainly less than required for, say, tying shoe laces or typing on a regular computer keyboard. So the inventor believes it is not necessary to design “left-handed” or “right-handed” cell phones based on handedness. Note that many existing handsets include thumb-wheels [sometimes called “jog dials”] on the left side of the handset, and for some applications these thumb-wheels can require more dexterity and hand-eye coordination than the proposed new side-buttons. But some people simply prefer to hold a phone in their left hand while others simply prefer to hold it in their right hand, so enabling operation of the modifier buttons by either hand (by placing the modifier buttons on each side of the device) can satisfy both preferences.

Cell phone handsets using the present invention would typically be used to access multiple mobile Internet services as well as voice services. Depending on the service offered by the service provider, a user might be able to access email, instant messaging, Web pages, remotely hosted applications, and other services. There are many ways to enable a user to indicate which service they want to use at a given moment: A thumb-wheel can be used to scroll through and select the options, as seen on some cell phone handsets today; side-buttons on either side of the phone can be used; buttons can be added to the face (or even the back) of the phone to allow users to switch between functions; or combinations of these features can be used.

The preferred embodiments described above are appropriate for languages with alphabets and upper-and lower-case languages. For languages that do not include upper-and lower-case letters, the Shift side-button is not needed: It can be left off, or another modifier side-button can be substituted, such as a “4th Letter” side-button, an “Alternative Letter” side-button, or some other side-button. For example, and “Alternative Letter” side-button could act like the “Alt” key or the “Ctrl” key on most PC keyboards—modifying the behavior of whatever other face-keys or side-buttons are pressed at the same time.

Inevitably, there will times at which users will want to backspace to undo what they've typed. FIG. 1 shows a backspace as the first character on the “1” face-key 112 at the top left of the handset's number keys. When in a context in which typing is required, a user can type a backspace simply by typing the “1” face-key (without holding in any side-buttons, since the backspace key is the first character on the “1” key). FIG. 4 shows an alternative configuration in which the backspace key 412 is separated into a large space bar on the left side of the phone -making it even easier for users to backspace. This is analogous to the enlarged backspace key on most computer keyboards.

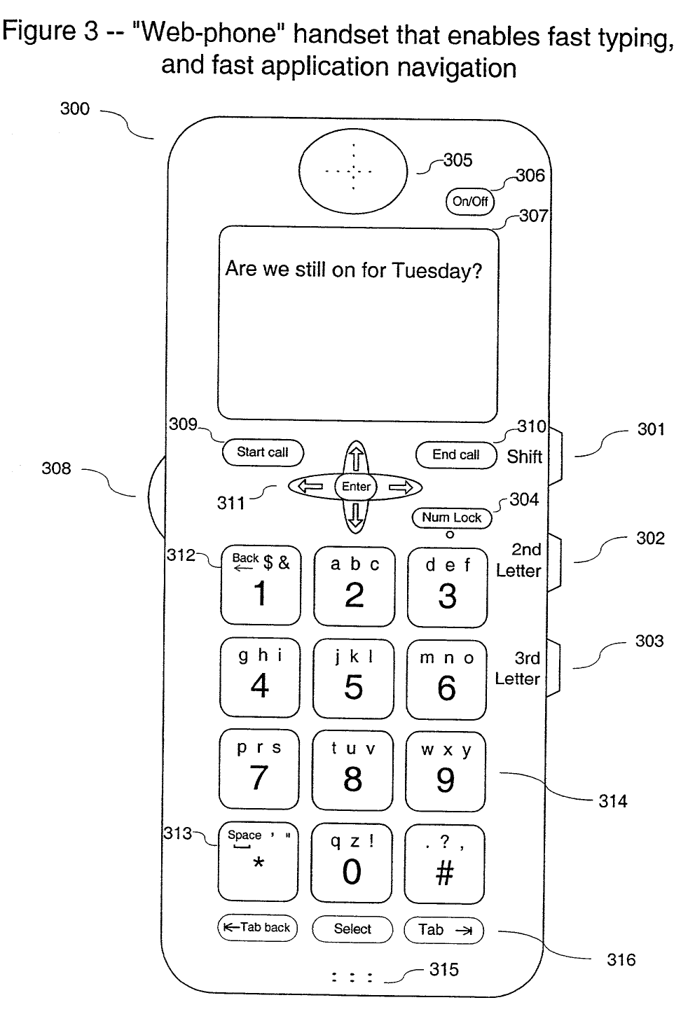

Increasingly, cell phone handsets (and other hand-held devices) are being used to view and interact with Web pages and applications—a trend that is likely to accelerate as new types of small displays allow users to view larger web-pages and application screens (or larger portions of them) on hand-held devices. As this trend accelerates, users will need easier ways to navigate through the Web pages and application forms on their small-devices, and better ways to select selectable items. As shown in FIG. 3, to allow users to quickly move through and select selectable items on Web-pages and application forms, three additional face-keys 316 can be introduced: The item in “focus” on the display is the item that will be selected if the user presses the “Select” face-key. Items can be buttons, check boxes, radio buttons, editable text boxes, or any other selectable item. If an editable text box is in focus, a text-entry marker should appear in that editable text box, indicating the place where the next character will appear when the user starts typing. (This is similar to what happens in word processors on most desktop computers today: A flashing “I-beam” text-entry marker shows where the next character to be typed will appear.) An application can set the initial focus to an appropriate item (such as the first selectable item in a form) whenever a new form, screen, window, or web page is presented. The user can then use a “Tab” face-key (as shown on the right side of the row of keys 316 illustrated in FIG. 3) to move the focus from one selectable item to the next one (among every selectable item on a Web page or application form). The user can use a “Tab back” face-key to move the focus from one selectable item to the previous one among every selectable item on a Web page or application form use the “Select” key to actually select the item that is currently in focus.

As with every other face-key or side-button described in this patent, the exact position and names of the face-keys or side-buttons can vary. One alternative to putting “Tab”, “Tab back” and “Select” keys on the face of the device is to put some or all of them on the side of the hand-set as side-buttons—preferably on the side of the phone where the users thumb would usually rest (for example, opposite the side where the “Shift”, “2nd Letter” and “3rd Letter” modifier buttons appear if they appear on only one side of the device). Another alternative would be to put some or all of them on the back of the device where the user could operate them using one or more fingers.

An alternative to having face-keys or side-buttons for “Tab”, “Tab back” and “Select” functions is to have a thumb-wheel 108 on the side of the phone (preferably the side where the user's thumb would sit). A user would roll the thumb-wheel with their thumb to quickly Tab-forward (when rolled in one direction) or Tab-backward (when rolled in the other direction) through all of the selectable items—changing the focus to the next or previous selectable item each time the wheel is rolled forward or backward by a given amount. In addition, the thumb-wheel could act as a button: when pressed into the handset, the item in focus would be selected. An alternative is to allow users to change the focus by rolling the thumb-wheel, but to require the user to push a “Select” face-key on the face of the handset to select the item currently in focus.

Most cell phone handsets include many of the items shown in FIGS. 1 through 4, including, as seen in FIG. 1, a speaker 105, an on/off button 106, a display 107, a button for starting calls 109, a button for ending calls 110, and a microphone 115.

FIG. 1 and FIG. 2 show a control that appears on many cell phone handsets on which users may need to type text—a left-arrow/right-arrow control 111 that lets users move the entry point backward or forward through text, such as text being typed. These operate just like the left-and right-arrows found on most computer keyboards. FIG. 3 and FIG. 4 show a more advanced form of this control—a left/right/up/down-arrow control 311 that lets users move left, right, up, or down through a block of text—just like the left, right, up, and down arrows found on most computer keyboards. And more advanced devices can include a full cursor control, allowing movement of a cursor in practically any direction over an image shown on a display on the device.

Users will sometimes want to be able type more characters than are available (or at least easily available) on most cell phone handsets. With the “Shift”, “2nd Letter”, and “3rd Letter” side-buttons described earlier (and shown in FIG. 1), users can already type more characters than on most cell phone handsets. And as shown in FIG. 2, adding a few more face-keys 216, allows users to type even more symbols. As shown in FIG. 2, to type the left-parenthesis character “(”, a user would simply type the face-key with that character on it. To type the left-bracket “[” character, a user would type that same face-key while holding in the “Shift” side-button (since the “r” character is shown above the “(” character on that face-key). To type the double-quote character ”, a user would type that same face-key while holding in the “2nd Letter” side-button, since the double-quote character is the 2nd character on that face-key. To type the single-quote character a user would type that same face-key while holding in the “Shift” side-button and the “2nd Letter” side-button, since the single-quote character is above the second character on that face-key. To type the right-parenthesis character “)”, a user would type that same face-key while holding in the “3rd Letter”, side-button, since the right-parenthesis character is the third character on that face-key. And to type the right-bracket character “]”, a user would type that same face-key while holding in the “Shift” side-button and the “3rd Letter” side-button, since the right-parenthesis character is above the third character on that face-key. The other characters on the other face-keys 216 shown across the bottom of the handset in FIG. 2 would be typed in a similar fashion.

The exact characters and positions on the keys, and the number of keys used, can vary, allowing a large range of possible characters to be typed with a given handset design. With the face-key layout shown in FIG. 4, for example, a user can type almost every character seen on a typical U.S. English computer keyboard. Other handset designs can add even more keys, allowing an even wider range of characters to be typed. And designers can use alternative controls to give users access to characters that are not represented on the face-keys: For example, an “alternative characters” button on the face or side of the device, or a thumb wheel on the front or side of the device, could allow users to scroll through alternative characters.

As described previously, the order of the side-buttons could be changed while still adhering to this invention, although we recommend the order shown in FIGS. 1 and 2 for the side-buttons, since this is an intuitive order for users, making it easy to learn. The positions of letters, symbols and even numbers on the face-keys can vary. A few variations have been shown in FIGS. 1, 2, 3, and 4.

FIG. 4, in particular, uses a slightly different positioning of the alphabet on the first nine phone-dialing face-keys than found on most phones designed to enable English typing. This is believed to be somewhat easier to learn and use than the alphabet layout used on traditional phones (which is similar to that sown in FIG. 1). Traditional phone handsets designed for English typing start the alphabet on the “2” key, put “pqrs” on the 7 key and “wxyz” on the 9 key, and put just three letters each on keys 3, 4, 5, 6, and 8. Older handsets leave off the q and z characters. The layout of letters on FIG. 4 is simpler in certain respects: In FIG. 4 the alphabet starts on the “1” key, proceeds through the number keys in order, and ends on the “9” key—allowing the full alphabet to reside in order on the top nine face-keys (in the 3×3 array of keys). And each key has three characters. Changing the letter positions relative to traditional phones may be a concern. But even today, different phones place the q and z characters in different positions. And since very few, if any, users have developed fast text-typing skills on current phone handsets, moving the letters is probably not a real problem. While it could be a bit confusing if a user has memorized a phone number using letters, such as “1-800-STOCKS5”, that may be of little concern for a handset designed for surfing the Web and for using Web-applications. Individual handset designers can choose the appropriate layout of letters for their particular handsets and customer base without departing from the spirit and scope of the invention.

Note that the handset design illustrated in FIG. 4 could be used for placing phone calls, instant messaging, email, Web-browsing, and calculations (e.g. using the hand-set as a calculator, for example, when calculating tips or splitting a bill in a restaurant).

This invention can also be used to augment Blackberry-like devices (with Qwerty keyboards) with a “Shift” button that a user could press with one hand while simultaneously typing a character key with the other hand. That makes typing upper case letters a little faster than having to press a “Shift” button and then having to press the character key—as two separate events. The Shift button can be placed on the side, top, or bottom of the QWERTY device. A preferred embodiment would be to have two shift buttons—one near the lower left of the QWERTY layout, and one near the lower right—similar to the placement on most full-size typing keyboards. That makes it easy for either hand to reach the shift button while the other hand types the character.

The general form of this invention can be used to allow users to generate different types of operations in addition to simply typing alphabetic text. For example, pressing one of the modifier buttons on the side of a device with this invention while simultaneously pressing a “menu” button on the face of the device could bring up a different menu than would appear when the menu button is pressed without that modifier button. And pressing one of the modifier buttons on the side of the device while simultaneously using the cursor control could do something interesting other than simply moving the cursor—such placing a phone call to the person or phone number that the cursor is over, for example. The point is that modifier keys can be used to modify the behavior of any other button or control on the device—simply by pressing the modifier keys while simultaneously operating that button or control. Although this patent application addresses “fast typing”, the invention can apply to operations other than typing.

Some languages (such as Chinese) involve large numbers of graphical characters—rather than a relatively small set of alphabetic characters. This invention could be used to allow users to efficiently write graphical characters stroke-by-stroke. This can be implemented in many ways. One example: Each key on the keypad on the face of the device would have three unique strokes written on it similar to how each key on an English phone has three main characters written on it. Above each key would be three more unique strokes similar to the way some of the keys in our previous example have additional characters written above them that can be accessed using the Shift modifier button. To type the first stroke on a key, a user would just press that key. To type the second stroke on a key, a user would type that key while simultaneously pressing a “2nd letter” modifier button on the side of the device. To type the third stroke on a key, the user would type that key while simultaneously pressing a “3rd letter” modifier button on the side of the device. To type any of the three additional strokes written above the key, they'd use the “Shift” modifier button. All of these modifier buttons could be given different names for this application. (For example, a device developer could choose to call the “Shift” button “Alt”, short for “alternative”, or choose to give it a non English name, or choose not to label it, or choose to label it with a symbol instead of a word, among other options. Similarly, a device developer could choose to label the “2nd Letter” modifier button “2^{nd}” or something else.) Software would write the strokes as the user typed them to form the full character: In effect, the user would draw characters stroke by stroke. When the user is done with a character, he or she could press a designated button on the phone on device (e.g. a “next character” button) to move onto the next character. It is also reasonable to have more or less than three unique strokes per key, or to have the same stroke on multiple keys. Three unique strokes per keypad key (plus three more accessible via the Shift modifier button) is just a convenient arrangement. A device developer could also choose to add a “4^{th} Letter” modifier button (perhaps calling it “4^{th}”), which would let the user type up to four strokes without depressing the Shift button, and type up to four more strokes when depressing the Shift button.

As noted, in an embodiment in which a device uses this invention to enable efficient typing of stroke-based graphical characters, software on the device would write each stroke as the user typed it (and optionally allow users to adjust the position of each stroke using buttons or other controls), forming a complete character stroke-by-stroke. When the user is done typing the strokes for a given character, the user could press a button (labeled, for example, “next character” or “character done” or simply having a unique symbol on it) indicating that that character is complete. Then the user could begin typing a new character, stroke-by-stroke. Here is pseudo-code illustrating this process for an example device with four modifier buttons on the side (labeled “Shift”, “2^{nd}”, “3^{rd}” and “4^{th}”), fifteen face-keys (each with up to eight strokes written on them), and a “next character” key:

// Codes corresponding to press or release of each modifier button

#define kShiftDown=b 1; // shift modifier button pressed

#define kShiftUp=2; // shift modifier button released

#define k2ndDown=3; // 2^{nd} button pressed

#define k2ndUp=4; // 3^{rd} button released

#define k3rdDown=5; // 3^{rd} button pressed

#define k3rdUp=6; // 3^{rd} button released

#define k4thDown=7; // 4th button pressed

#define k4thUp=8; // 4th button released

// Code corresponding to pressing of “next character” button

#define kNextCharDown=10;

// Codes corresponding to pressing of face-keys used to type strokes

#define k1stFaceKey=101;

#define k2ndFaceKey=102;

. . . etc. . . .

#define k15thFaceKey=115;

// Assume that there is a queue—such as a serial port queue—where

// the firmware writes one of the above codes whenever a user

// operates one of the modifier buttons or face keys

IntegerQueue Q;

// Also define a unique constant

// for each unique stroke that can be typed

// -- up to 8 strokes on each of the 15 face keys.

#define kStroke0101=101;

#define kStroke0102=102;

#define kStroke0103=103;

. . . etc. . . .

#define kStroke1507=1507;

#define kStroke1508=1508;

// In various contexts, the device should interpret key and button presses

// as typing—for example, to let the user type email or instant messages

int code=0;

boolean gShift=false;

boolean g2ndstroke=false;

boolean g3rdStroke=false;

boolean g4thStroke=false;

char strokeToType=null;

while (in-typing-context){

strokeToType=null;

code=ReadFromQueue(Q); // fetch the next code from Queue

// set shift, 2^{nd}, 3^{rd}, 4^{th} variables according to most recent

// press or release of corresponding modifier button

if (code==kShiftDown) gShift=true;

else if (code==kShiftUp) gShift=false;

else if (code==k2ndDown) g2ndStroke=true;

else if (code==k2ndUp) g2ndStroke=false;

else if (code==k3rd Down) g3rdStroke=true;

else if (code==k3rdUp) g3rdStroke=false;

else if (code==k4thDown) g4thStroke=true;

else if (code==k4thUp) g4thStroke=false;

// if the “next character” button is pressed, assume

// the user is done typing the current character

else if (code==kNextCharDown) {

Finish TypingCurrentChar ( );

}

// Process typed strokes

// Handle each face button pressed with any combination

// of modifier buttons simultaneously depressed.

if (code==k1stFaceKey) {// user pressed 1^{st} face key

if (g4thStroke) {

if (gshift) strokeToType=kStroke0108; // 8^{th} stroke on 1^{st} key

else strokeToType=kStroke0107; // 7^{th} stroke on 1^{st} key

} else if (g3rdStroke) {

if (gshift) strokeToType=kStroke0106; // 6^{th} stroke on 1^{st} key

else strokeToType=kStroke0105; // 5th stroke on 1^{st} key

} else if (g2ndStroke) {

if (gshift) strokeToType=kStroke0104; // 4^{th} stroke on 1^{st} key

else strokeToType=kStroke0103; // 3rd stroke on 1^{st} key

} else {

if (gshift) strokeToType=kStroke0102; // 2nd stroke on 1^{st} key

else strokeToType=kStroke0101; // 1st stroke on 1^{st} key

}

}

else if (code==k2ndFaceKey){ // user pressed 2nd face key

if (g4thStroke) {

if (gshift) strokeToType=kStroke0208; // 8th stroke on 2nd key

else strokeToType kStroke0207; // 7th stroke on 2nd key

} else if (g3rdStroke) {

if (gshift) strokeToType=kStroke0206; // 6th stroke on 2nd key

else strokeToType=kStroke0205; // 5th stroke on 2nd key

} else if (g2ndStroke) {

if (gShift) strokeToType=kStroke0204; // 4th stroke on 2nd key

else strokeToType=kStroke0203; // 3rd stroke on 2nd key

} else {

if (gshift) strokeToType=kStroke0202; // 2nd stroke on 2nd key

else strokeToType=kStroke0201; // 1st stroke on 2nd key

}

}

. . . etc. handling each face key up to the last one . . .

else if (code==k15thFaceKey) { // user pressed 15th face key

if (g4thStroke) {

if (gshift) strokeToType=kStroke1508; // 8th stroke on 15th key

else strokeToType=kStroke1507; // 7th stroke on 15th key

} else if (g3rdStroke) {

if (gshift) strokeToType=kStroke1506; // 6^{th} stroke on 15th key

else strokeToType=kStroke1505; // 5th stroke on 15th key

} else if (g2ndStroke) {

if (gShift) strokeToType=kStroke1504; // 4^{th} stroke on 15th key

else strokeToType=kStroke1503; // 3rd stroke on 15th key

} else {

if (gShift) strokeToType=kStroke1502; // 2nd stroke on 15th key

else strokeToType=kStroke1501; // 1st stroke on 15th key

}

} II done interpreting keys and buttons to identify which stroke was typed

// Add stroke to current character being typed

if (strokeToType !=null) TypeStrokeInCurrentChar (strokeToType);

} // end of while loop

// end of pseudo-code example

As illustrated in a previous pseudo-code example, a lookup table could be used to more efficiently interpret codes sent to the code queue when buttons and keys are typed, rather than using dozens of if-then statements. And as illustrated in a previous pseudocode example, the device could also include a “Num Lock” face key that allows users to type an additional symbol on each key—such as a digit or non-alphabetic symbol.

This invention can be used to develop devices that allow users to type characters, strokes, symbols, or entire words, or generate functions—all on the same device_simply by typing different combinations of keys and modifier buttons. As an extreme example (for illustration), one can imagine a device on which typing a given face key without concurrently depressing any modifier buttons might generate the letter “a”, typing that same key with the Shift modifier button depressed might generate the uppercase letter “A”, typing the same key with the “2nd Letter” modifier button depressed without the Shift modifier button depressed might generate a happy-face symbol (or other graphical object), typing the same key with the “2^{nd} Letter” modifier button depressed and the Shift modifier button depressed might trigger a “fetch new email” function” (as an example of a function that could be available on the device), typing the same key with the “3^{rd} Letter” modifier button depressed without the Shift modifier button depressed might generate a graphical stroke (part of a Chinese graphical character, for example), typing the same key with the “3^{rd} Letter” modifier button depressed and with the Shift modifier button depressed might generate a complete Chinese character, typing the same key with the “4^{th} Letter” modifier button depressed (assuming the device has one) without the Shift button depressed might generate the entire word “Yes”, and typing the same key with the “4^{th} Letter” modifier button depressed and the Shift button depressed might generate the full word “No”. In this example, the user is able to type up to 8 different things by typing a single key while concurrently depressing different combinations of the modifier buttons. If there were, say, 15 face keys on this example device, then the user could type any of up to 120 (8×15) different characters, strokes, symbols, words or functions with a single typing event (where by “typing event” we mean typing a single face-key with one hand while simultaneously depressing some combination of modifier buttons with the other hand.) A device can have redundant copies of the modifier buttons. For example, one of our sample devices will have Shift, 2nd-Letter, and 3rd-Letter buttons on each side of the device—to make it easier for users to hold and operate the phone with either hand. (A device that has redundant copies of the modifier buttons could also include a removable cover that the user could place over the modifier buttons on one side of the device or the other, just to cover up the buttons on one side if the user knows that he or she will only be using the buttons on the other side.)

The modifier buttons can be placed in any appropriate location. For example, one potentially useful configuration would place them at the bottom of the face of the device below the rest of the keypad. Then the user could operate a modifier key with the thumb of one hand while simultaneously pressing a keypad key with the other hand.

But our preferred embodiment places the modifier buttons on the side of the device where they can be operated with the index, middle, and ring finger of the hand holding the device, while the other hand types keys on the keypad of the device. My invention carefully placed the buttons so a person's index, middle and ring fingers can naturally rest on the three modifier buttons on one side of the device as they hold the device, while the thumb rests comfortably on the other side of the device.

Another embodiment of this invention is to place the side modifier buttons in indentations or “finger wells” that conform to the fingers of the hand that is holding the phone.

In another embodiment, a relatively simple set of sliding panels could let the user move the buttons up or down the side of the device, to position them where that user feels most comfortable operating those modifier keys.

Another embodiment is to have a removable strip of modifier buttons on one side of the device that the user can slide out and insert into the other side of the device. This would let the user choose which side of the device has the modifier buttons (i.e. which hand do they want to hold the device while operating the modifier buttons). As noted earlier, one alternative to this is to simply include modifier buttons on both sides of the phone.

This invention can be applied to a wide range of hand-held devices: remote controls for Interactive TV and Web-enabled Internet appliances, input devices for remote monitoring stations for use by field workers, mobile input devices (e.g. for use by people such as FedEx workers), and so on. It's particularly useful when combined with a display in the same device where the text being typed will be viewed.

Many other features can be added to or combined with the phones outlined above. For example, software exists that attempts to automatically finish words before the user is finished typing them. With this software, the user might type “comp” and the software might write out the word “computer”. The user can then hit an enter key to accept that word, or the user can keep typing. If the user's next character is “r”—“compr”—then the software might write out the word “compromise”, guessing that that is the word the user wants to type. Microsoft's Internet Explorer uses automatic-word finishing when users type URLs, for example. Automatic word finishing can help some people type faster in some contexts, although it can also be a bit distracting. Automatic word finishing can be used in conjunction with all of the embodiments described in this document.

I have described the invention in detailed preferred embodiments, including preferred methods of operation. It is to be understood, however, that this description and operation could be carried out with different elements and steps than those described. These embodiments are presented as examples only and are not meant to limit the spirit or the scope of this invention, which is defined by the following claims:

1. A hand-held electronic device having at least one face-key and having one or more modifier buttons on one side of the device, wherein a user of said device can hold the device with one hand and type a character or invoke a function by depressing one of the at least one face-keys using a finger on the hand that is not holding the device while concurrently depressing none of, one of, or a combination of the one or more modifier buttons with fingers on the hand that is holding the device.

2. The device of claim 1 including two modifier buttons and having a plurality of characters associated with at least one face-key, wherein concurrently depressing said at least one face-key without depressing any modifier button results in generating a first character associated with said face-key.

3. The device of claim 2 wherein concurrently depressing said face-key and one modifier button results in generating a second character associated with said face-key.

4. The device of claim 3 wherein concurrently depressing said face-key and a second modifier button results in generating a third character associated with said face-key.

5. The device of claim 4 including a third modifier button wherein concurrently depressing said face-key and said third modifier button results in generating a fourth character associated with said face-key.

6. The device of claim 1 having a “Num” button located on the side of the device and having said at least one face-key further having a number such as “0” to “9” or a non-alphabetic character such as “*” or “#” associated therewith, wherein concurrently depressing said at least one face-key and said Num button generates said number or non-alphabetic character.

7. The device of claim 1 having a first modifier button wherein concurrently depressing said first modifier button and one of said at least one face-key and any particular combination of zero, one, or more than one additional modifier buttons the device may have can result in generating a different character or function than would result from concurrently depressing said face-key and said combination of said zero, one, or more than one additional modifier buttons without concurrently depressing said first modifier button.

8. The device of claim 7 wherein said first modifier button is designated a Shift button.

9. The device of claim 1 having a “Num Lock” button located on the face of said device wherein (a) depressing the Num Lock button a first time results in the subsequent depressing of any of said at least one face-button generating said numbers or non-alphabetic characters and (b) thereafter depressing the Num Lock button results in the subsequent depressing of any of said at least one face-button generating alphabetic characters.

10. The device of claim 1 having a Space Bar button located as a side key or located as a face-key larger than said at least one face-key, wherein depressing said Space Bar results in a space being generated in typed text.

11. The device of claim 1 having a Backspace button located as a side key or located as a face-key larger that said at least one face-key, wherein depressing said Backspace button results in deleting a character.

12. The device of claim 1 wherein the modifier buttons are on sliding panels to allow the position of the modifier buttons on the side of the device to be adjusted.

13. The device of claim 1 wherein the modifier buttons are contained in a removable strip of modifier buttons on one side of the device that can be removed and inserted into the other side of the device.

14. The device of claim 1 having three modifier buttons, wherein the modifier buttons are placed so as to be operable by the index, middle and ring finger of the hand holding the device.

15. The device of claim 1 wherein the at least one face-keys are on a ten-key key pad.

16. The device of claim 1 wherein the modifier buttons are on both sides of the device and are operable to enable a user to hold the device and operate the modifier buttons with either hand.

17. The device of claim 1 having four modifier buttons, wherein the modifier buttons are placed so as to be operable by the index, middle, ring and pinky finger of the hand holding the device.

18. The device of claim 1 wherein at least one of the modifier buttons is placed in a finger well.

19. A hand-held electronic device having a plurality of face-keys, one or more displays and one or more modifier buttons located on one or both sides of said device wherein a user types a character or invokes a function by depressing one of the face-keys while simultaneously depressing none of, one of, or a combination of the one or more modifier buttons.

20. The device of claim 19 wherein depressing a face-key without depressing any of the modifier buttons produces a given character or function and depressing the same face-key while simultaneously depressing one or a combination of the modifier buttons can result in a different character or function.

21. The device of claim 19 further including a menu button, wherein depressing one of the modifier buttons while simultaneously depressing the menu button causes a different menu to be generated than would appear when the menu button is depressed without depressing said modifier button.

22. The device of claim 19 further including a cursor control component for controlling a cursor on at least one of said one or more displays wherein depressing a particular combination of one or more of the modifier buttons while simultaneously operating said cursor control component will cause a function other than the function that occurs when said cursor control component is operated without simultaneously depressing said combination of one or more modifier buttons.

23. The device of claim 22 wherein the device is a cell phone and the function caused by operating the cursor control component while simultaneously depressing a particular combination of one or more modifier buttons when the cursor is over a person's name displayed on said one or more displays is placing a phone call to the person whose name the cursor is over.

24. The device of claim 22 wherein the device is a cell phone and the function caused by operating the cursor control component while simultaneously depressing a particular combination of one or more modifier buttons when the cursor is over a telephone number displayed on said one or more displays is placing a phone call to the telephone number the cursor is over.

25. The device of claim 19 wherein depressing the said one of said face-keys while simultaneously depressing a given combination of the modifier buttons can result in a different character or function being generated than is generated when said face-key is depressed while simultaneously depressing a different combination of modifier buttons or while not depressing any modifier buttons.

26. The device of claim 19 including two modifier buttons and having a plurality of characters associated with at least one face-key, wherein concurrently depressing one face-key without depressing any modifier button results in generating a first character associated with said face-key.

27. The device of claim 26 wherein concurrently depressing said one face-key and one modifier button results in generating a second character associated with said face-key.

28. The device of claim 27 wherein concurrently depressing said one face-key and a second modifier button results in generating a third character associated with said face-key.

29. The device of claim 28 including a third modifier button wherein concurrently depressing said face-key and said third modifier button results in generating a fourth character associated with said face-key.

30. The device of claim 19 having a “Num” side-key and said at least one face-key further having a number such as “0” to “9”, or a non-alphabetic character such as “*” or “#” associated therewith, wherein concurrently depressing said at least one face-key and said Num side-key generates said number or character.

31. The device of claim 19 having a Shift side modifier button wherein concurrently depressing said Shift button and one of said at least one face-key and any particular combination of zero, one, or more than one additional modifier buttons the device may have can result in generating a different character or function than would result from concurrently depressing said face-key and said combination of said zero, one, or more than one additional modifier buttons without concurrently depressing said Shift button.

32. The device of claim 19 having a “Num Lock” button located on the face of said device wherein (a) depressing the Num Lock face-button a first time results in the subsequent depressing of any of said at least one face-button generating said numbers or non-alphabetic characters and (b) thereafter depressing the Num Lock face-button results in the subsequent depressing of any of said at least one face-button generating alphabetic characters.

33. The device of claim 19 having a Space Bar button located as a side key or located as a face-key larger than said at least one face-key, wherein depressing said Space Bar results in a space being generated in typed text.

34. The device of claim 19 having a Backspace button located as a side key or located as a face-key larger that said at least one face-key, wherein depressing said Backspace button results in deleting a character.

35. The device of claim 19 used to focus electronically on selectable items of World Wide Web pages or other application documents or forms using at least one of said one or more displays.

36. The device of claim 35 having a Tab-Forward button located as a side key or located as a face-key, wherein depressing said Tab-Forward button results in quickly moving the focus from a first selectable item on the page, document or form to the next selectable item on the page, document or form.

37. The device of claim 36 having a Tab-Backward button located as a side-key or as a face-key, wherein depressing said Tab-Backward button results in quickly moving the focus from a first selectable item on the page, document or form to the previous selectable item on the page, document or form.

38. The device of claim 35 having a Select button, wherein depressing said Select button results in selecting the item currently in focus.

39. The device of claim 19 wherein the device is a wireless telephone.

40. The device of claim 19 wherein said device is a remote control for interactive television or Web-enabled Internet appliances.

41. The device of claim 19 wherein the device is an input device for remote monitoring stations for use by field workers.

42. The device of claim 35 having a thumb wheel located on the front or on one side or both sides of said device wherein (1) rolling said thumb wheel in one direction with a thumb or other finger results in tabbing forward among said selectable items, and (2) rolling said thumb wheel in the other direction with a thumb or other finger results in tabbing backward among said selectable items.

43. The device of claim 42 wherein the thumb wheel can additionally be depressed to select the item currently in focus.

44. The device of claim 19 having three modifier buttons, wherein the modifier buttons are placed so as to be operable by the index, middle and ring finger of the hand holding the device.

45. The device of claim 19 having four modifier buttons, wherein the modifier buttons are placed so as to be operable by the index, middle, ring and pinky finger of the hand holding the device.

46. The device of claim 19 wherein at least one modifier button is placed in a finger well.

47. A hand-held electronic device having a standard Qwerty keyboard, said Qwerty keyboard having character keys and having a shift button wherein a user depresses said shift button with one hand while simultaneously depressing a character key with the other hand.

48. The hand-held device of claim 47 having a first shift button on the Qwerty keyboard and a second shift button on the Qwerty keyboard wherein either hand can depress one of said shift buttons while the other hand depresses a character key.

49. The hand-held device of claim 48 wherein the first additional shift button is at the lower left of the keyboard and the second additional shift button is at the lower right of the keyboard.

50. The hand-held device of claims 1 or 19 wherein the Shift modifier button can be placed on the side, top, or bottom of the device.

51. A hand-held electronic device having a plurality of face-keys, one or more displays, and one or more modifier buttons located on the face of said device or on one or both sides of said device, wherein a user types a graphical stroke or invokes a function by depressing one of the face-keys while simultaneously depressing none, one or combinations of the modifier buttons.

52. The device of claim 51 wherein a plurality of the keys each has a number of graphical strokes associated with it.

53. The device of claim 52 wherein depressing solely one of said plurality of face-keys causes a first predetermined one of the graphical strokes to be generated, depressing said one face key while depressing one modifier button causes a second predetermined one of the graphical strokes to be generated, depressing said one key while depressing a second modifier button causes a third predetermined one of the graphical strokes to be generated, and, if the device includes a third modifier button, depressing said one face key while depressing said third modifier button causes a fourth predetermined one of the graphical strokes to be generated.

54. The device of claim 53 in addition having a first modifier button wherein concurrently depressing the first modifier button and a particular face-key and a particular combination of zero, one, or more than one additional modifier buttons can cause a different graphical stroke or function to be generated than is generated if said face-key and said combination of modifier buttons are concurrently depressed without said first modifier button being depressed.

55. The device of claim 54 wherein the first modifier button is designated a Shift button.

56. The device of claim 53 wherein software contained in said device causes the graphical strokes to form a character or a graphical figure from said graphical strokes for display on said display.

57. The device of claims 56 having a control button, wherein depressing said control button causes said software to consider the current character or graphical figure complete and to allow the user to begin typing a subsequent character or graphical figure.

58. The device of claim 57 wherein said control button is designated a “next character” button.

59. A computer implemented process for interpreting keystrokes on a hand-held electronic device having at least one face-key and having at least one modifier button on one or both sides of the device, wherein a user of said device can hold the device with one hand and type a character or invoke a function by depressing one of the at least one face-keys using a finger on the hand that is not holding the device while concurrently depressing one or a combination of the at least one modifier button with fingers on the hand that is holding the device, and generating typed characters,
the process including the steps of
sending to a queue a unique code for each key and button that is depressed or released,
searching for new codes to appear in the queue as keys and buttons are depressed or released,
interpreting said codes as functions including, but not limited to, typing, and
continually reading such codes and interpreting them as such functions.

60. The computer implemented process of claim 59 further including the step of generating character codes representing each character that is typed.

61. The computer implemented process of claim 60 wherein the step of interpreting codes as typing triggers sending the generated character codes representing typed characters to a text buffer.

62. The computer implemented process of claim 59 wherein a table lookup process is used to interpret said codes.

63. The computer implemented process of claim 59 including the step of interpreting the depressing and holding of a given combination of one key and zero, one, or more than one buttons for longer than some minimal amount of time as an indication to provide additional useful functions.

64. The computer implemented process of claim 63 wherein one of said useful functions is autotyping.

65. A computer implemented process for interpreting keystrokes on a hand-held electronic device having a plurality of face-keys, one or more displays, and one or more modifier buttons located on one or both sides of said device wherein a user types a character or invokes a function by depressing one of the face-keys while simultaneously depressing none of, one of, or a combination of the one or more modifier buttons,
the process including the steps of
sending to a queue a unique code for each key and button that is depressed or released,
searching for new codes to appear in the queue as keys and buttons are depressed or released,
interpreting said codes as functions including, but not limited to, typing, and
continually reading such codes and interpreting them as such functions.

66. The computer implemented process of claim 65 including the further step of generating character codes representing each character that is typed.

67. The computer implemented process of claim 66 including the further step of displaying said character codes as typing on said one or more displays.

68. The computer implemented process of claim 67 wherein the step of interpreting codes as typing triggers sending the generated character codes representing each character to a text buffer.

69. The computer implemented process of claim 65 wherein a table lookup process is used to interpret said codes.

70. The computer implemented process of claim 65 including the step of interpreting the depressing and holding of a given combination of one key and zero, one, or more than one buttons for longer than some minimal amount of time as an indication to provide additional useful functions.

71. The computer implemented process of claim 70 wherein said useful function is autotyping.

72. The computer implemented process of claim 65 further including the steps of
(a) interpreting the depressing of a face-key without depressing any of the modifier buttons as generating a given character or function and
(b) interpreting the depressing of the same face-key while simultaneously depressing one or a combination of the modifier buttons as generating a different character or function.

73. The computer implemented process of claim 65 wherein the device includes a menu button, and wherein the depressing one of the modifier buttons while simultaneously depressing the menu button generates one or more codes that are interpreted as an instruction for causing a different menu to be generated than would appear when the menu button is depressed without depressing said modifier button.

74. The process of claim 65 wherein the device includes a cursor control component for controlling a cursor on at least one of said one or more displays, wherein depressing a particular combination of one or more of the modifier buttons while simultaneously operating said cursor control component generates one or more codes that are interpreted as an instruction for causing a function other than the function that is generated when said cursor control component is operated without said combination of modifier buttons being simultaneously depressed.

75. The process of claim 74 wherein the device is a cell phone and the function caused by operating the cursor control while simultaneously depressing a particular combination of one or more modifier buttons when the cursor is over a person's name displayed on said one or more displays is placing a phone call to the person whose name the cursor is over.

76. The process of claim 74 wherein the device is a cell phone and the function caused by operating the cursor control while simultaneously depressing a particular combination of one or more modifier buttons when the cursor is over a telephone number displayed on said one or more displays is placing a phone call to the telephone number the cursor is over.

77. The process of claim 65 wherein depressing the said one of said face-keys while simultaneously depressing a given combination of the modifier buttons generates one or more codes that are interpreted as an instruction for a different character or function being generated than is generated when said face-key is depressed while simultaneously depressing a different combination of modifier buttons or while not depressing any modifier buttons.

78. The process of claim 65 wherein the device includes two modifier buttons and has a plurality of characters associated with at least one face-key, wherein concurrently depressing one face-key without depressing any modifier button generates one or more codes that are interpreted as an instruction for generating a first character associated with said face-key.

79. The process of claim 78 wherein concurrently depressing said one face-key and one modifier button generates one ore more codes that are interpreted as an instruction for generating a second character associated with said face-key, and wherein concurrently depressing said one face-key and a second modifier button generates one ore more codes that are interpreted as an instruction for generating a third character associated with said face-key.

80. The process of claim 79 wherein the device includes a third modifier button and wherein concurrently depressing said at least one face-key and said third modifier button generates one or more codes that are interpreted as an instruction for generating a fourth character associated with said face-key.

81. The process of claim 65 wherein the device includes a “Num” side-key and said at least one face-key further having a number such as “0” to “9” or a non-alphabetic character such as “*” or “#” associated therewith, wherein concurrently depressing said at least one face-key and said Num side-key generates one or more codes that are interpreted as an instruction for generating said number or character.

82. The process of claim 65 wherein the device includes a Shift side modifier button and wherein concurrently depressing said Shift button and one of said at least one face-key and any particular combination of zero, one, or more than one additional modifier buttons the device may have generates one or more codes that are interpreted as an instruction for generating a different character or function than would result from concurrently depressing said face-key and said combination of said zero, one, or more than one additional modifier buttons without concurrently depressing said Shift button.

83. The process of claim 65 wherein the device has a “Num Lock” button located on the face of said device and wherein
(c) depressing the Num Lock face-button a first time results in the subsequent depressing of any of said at least one face-keys generates one or more codes interpreted as an instruction for generating said numbers or non-alphabetic characters and
(d) thereafter depressing the Num Lock face-button results in the subsequent depressing of any of said at least one face-keys generates one or more codes interpreted as an instruction for generating alphabetic characters.

84. The process of claim 65 wherein the device has a Space Bar button located as a side-key or located as a face-key larger than said at least one face-key, and wherein depressing said Space Bar generates one ore more codes that are interpreted as an instruction for a space being generated in typed text.

85. The process of claim 65 wherein the device has a Backspace button located as a side-key or located as a face-key larger that said at least one face-key, wherein depressing said Backspace button generates one or more codes that are interpreted as an instruction for deleting a character.

86. The process of claim 65 wherein the device is used to focus electronically on selectable items of World Wide Web pages or other application documents or forms using at least one of said one or more displays and has a Tab-Forward button located as a side-key or located as a face-key, wherein depressing said Tab-Forward button generates one or more codes that are interpreted as an instruction for quickly moving the focus from a first selectable item on the page, document or form to the next selectable item on the page, document or form.

87. The process of claim 86 wherein the device has a Tab-Backward button located as a side-key or as a face-key, wherein depressing said Tab-Backward button generates one or more codes interpreted as an instruction for quickly moving the focus from a first selectable item on the page, document or form to the previous selectable item on the page, document or form.

88. The process of claim 86 wherein the device has a Select button located as a side-key or as a face-key, and wherein depressing said Select button generates one or more codes that are interpreted as an instruction for selecting the item currently in focus.

89. The process of claim 65 wherein the device is used to focus electronically on selectable items of World Wide Web pages or other application documents or forms using at least one of said one or more displays and has a thumb wheel located on the front or on one side or both sides of said device, and wherein (1) rolling said thumb wheel in one direction with a thumb or other finger generates codes interpreted as instructions for tabbing forward among said selectable items, and (2) rolling said thumb wheel in the other direction with a thumb or other finger generates codes interpreted as instructions for tabbing backward among said selectable items.

90. The process of claim 89 wherein depressing the thumb wheel generates one or more codes interpreted as an instruction to select the item currently in focus.

91. A computer implemented process for interpreting keystrokes on a hand-held electronic device having a plurality of face-keys, one or more displays, and one or more modifier buttons located on the face of said device or on one or both sides of said device, wherein
(a) a plurality of the keys each has a number of graphical strokes associated with it, and
(b) depressing solely one of said plurality of face-keys generates a first code interpreted as an instruction to generate a predetermined one of the graphical strokes; depressing said one key while depressing one modifier button generates a second code interpreted as an instruction to generate a second predetermined one of the graphical strokes; depressing said one key while depressing a second modifier button generates a third code interpreted as an instruction to generate a third predetermined one of the graphical strokes; and, if the device includes a third modifier button, depressing said one face key while depressing said third modifier button causes a fourth predetermined one of the graphical strokes to be generated.

92. The process of claim 91 wherein the device has a Shift button wherein concurrently depressing the Shift button and a particular face-key and a particular combination of zero, one, or more than one modifier buttons can generate one or more codes interpreted as an instruction to generate a different graphical stroke or function than is generated if said face-key and said combination of modifier buttons are concurrently depressed without said Shift button being depressed.

93. The process of claim 92 including the further steps of generating codes interpreted as instructions to cause the graphical strokes to form a character or a graphical figure from said graphical strokes for display on said one or more display.

94. A storage medium having embedded therein computer code comprising computer implemented process for interpreting keystrokes on a hand-held electronic device having at least one face-key and having at least one modifier button on one or both sides of the device, wherein a user of said device can hold the device with one hand and type a character or invoke a function by depressing one of the at least one face-keys using a finger on the hand that is not holding the device while concurrently depressing none of, one of, or a combination of the at least one modifier button with fingers on the hand that is holding the device, and generating typed characters,
the process, when said storage medium is used in said device, including the steps of
sending to a queue a unique code for each key and button that is depressed or released,
searching for new codes to appear in the queue as keys and buttons are depressed or released,
interpreting said codes as functions including, but not limited to, typing, and
continually reading such codes and interpreting them as such functions.

95. The storage medium of claim 94 wherein the computer-implemented process further includes the step of generating character codes representing each character that is typed.

96. The storage medium of claim 94 wherein the step of interpreting codes as typing triggers sending the generated character codes representing each character to a text buffer.

97. The storage medium of claim 94 wherein a table lookup process is used to interpret said codes.

98. The storage medium of claim 94 wherein the computer implemented process includes the step of interpreting the depressing and holding of a given combination of at least one key and zero, one, or more than one buttons for longer than some minimal amount of time as an indication to provide additional useful functions.

99. The storage medium of claim 98 wherein one of said useful functions is autotyping.

100. A storage medium having embedded therein computer code comprising a computer implemented process for interpreting keystrokes on a hand-held electronic device having a plurality of face-keys, one or more displays, and one or more modifier buttons located on one or both sides of said device wherein a user types a character or invokes a function by depressing one of the face-keys while simultaneously depressing none of, one of, or a combination of the one or more modifier buttons,
the process, when said storage medium is used in said device, including the steps of
sending to a queue a unique code for each key and button that is depressed or released,
searching for new codes to appear in the queue as keys and buttons are depressed or released,
interpreting said codes as functions including, but not limited to, typing of characters, symbols, strokes or words,
displaying said typed characters, symbols, strokes or words on said one or more displays, and
repeating said steps of sending codes to a queue, reading codes from the queue, interpreting said codes, and, when the codes are interpreted as typing, displaying said typed items in said one or more displays.

101. The storage medium of claim 100 wherein the computer-implemented process further includes the step of generating character codes representing each character that is typed.

102. The storage medium of claim 95 wherein the step of interpreting codes as typing triggers sending the generated character codes representing each character to a text buffer.

103. The storage medium of claim 100 wherein the computer-implemented process uses a table lookup process to interpret said codes.

104. The storage medium of claim 100 wherein the computer implemented process includes the step of interpreting the depressing and holding of a given combination of one key and zero, one, or more than one buttons for longer than some minimal amount of time as an indication to provide additional useful functions.

105. The storage medium of claim 104 wherein said useful function is autotyping.

106. The storage medium of claim 100 wherein the computer implemented process further includes the steps of
(a) interpreting the depressing of a face-key without depressing any of the modifier buttons as generating a given character or function and
(b) interpreting the depressing of the same face-key while simultaneously depressing one or a combination of the modifier buttons as generating a different character or function.

107. The storage medium of claim 100 wherein the device includes a menu button, and the computer implemented process includes interpreting the depressing one of the modifier buttons while simultaneously depressing the menu button as causing a different menu to be generated than would appear when the menu button is depressed without depressing said modifier button.

108. The storage medium of claim 100 wherein the device includes a cursor control component for controlling a cursor on at least one of said one or more displays, and wherein depressing a particular combination of one or more of the modifier buttons while simultaneously operating the cursor control component generates one or more codes that are interpreted as an instruction for causing a function other than the function generated when said cursor control component is operated without simultaneously depressing said combination of modifier buttons.

109. The storage medium of claim 108 wherein the device is a cell phone and the function caused by operating the cursor control while simultaneously depressing a particular combination of one or more modifier buttons when the cursor is over a person's name displayed on said one or more displays is placing a phone call to the person whose name the cursor is over.

110. The storage medium of claim 108 wherein the device is a cell phone and the function caused by operating the cursor control while simultaneously depressing a particular combination of one or more modifier buttons when the cursor is over a telephone number displayed on said one or more displays is placing a phone call to the telephone number the cursor is over.

111. The storage medium of claim 100 wherein depressing the said one of said face-keys while simultaneously depressing a given combination of the modifier buttons causes the process to generate codes that are interpreted as an instruction to generate a different character or function than is generated when said face-key is depressed while simultaneously depressing a different combination of modifier buttons or while not depressing any modifier buttons.

112. The storage medium of claim 100 wherein the device includes two modifier buttons and has a plurality of characters associated with at least one face-key, wherein in response to a user concurrently depressing one of said at least one face-key without depressing any modifier button the computer implemented process generates one or more codes that are interpreted as an instruction for generating a first character associated with said face-key.

113. The storage medium of claim 112 wherein in response to the user concurrently depressing said at least one face-key and one modifier button the computer implemented process generates one or more codes that are interpreted as an instruction for generating a second character associated with said face-key; and wherein in response to a user concurrently depressing said at least one face-key and a second modifier button the computer implemented process generates one or more codes that are interpreted as an instruction for generating a third character associated with said face-key.

114. The storage medium of claim 113 wherein in response to a user concurrently depressing said at least one face-key and a third modifier button the computer implemented process generates one or more codes that are interpreted as an instruction for generating a fourth character associated with said face-key.

115. The storage medium of claim 100 wherein the device includes a “Num” side-key and said at least one face-key further having a number such as “0” to “9” or a non-alphabetic character such as “*” or “#” associated therewith, wherein in response to a user concurrently depressing said at least one face-key and said Num side-key the computer implemented process generates one or more codes that are interpreted as an instruction for generating said number or character.

116. The storage medium of claim 100 wherein the device includes a Shift side modifier button and wherein in response to a user concurrently depressing said Shift button and one of said at least one face-key and any particular combination of zero, one, or more than one additional modifier buttons the device may have the computer implemented process generates one or more codes that are interpreted as an instruction for generating a different character or function than would result from the user concurrently depressing said face-key and said combination of said zero, one, or more than one additional modifier buttons without concurrently depressing said Shift button.

117. The storage medium of claim 100 wherein the device has a “Num Lock” button located on the face of said device and wherein
(a) depressing the Num Lock face-button a first time results in the subsequent depressing of any of said at least one face-keys causing the computer implemented process to generate one or more codes interpreted as an instruction for generating said numbers or non-alphabetic characters and
(b) thereafter depressing the Num Lock face-button results in the subsequent depressing of any of said at least one face-keys causing the computer implemented process to generate one or more codes interpreted as an instruction for generating alphabetic characters.

118. The storage medium of claim 100 wherein the device has a Space Bar button located as a side-key or located as a face-key larger than said at least one face-key, wherein in response to a user depressing said Space Bar the computer implemented process generates one or more codes that are interpreted as an instruction for a space being generated in typed text.

119. The storage medium of claim 100 wherein the device has a Backspace button located as a side-key or located as a face-key larger that said at least one face-key, wherein in response to a user depressing said Backspace button the computer implemented process generates one or more codes that are interpreted as an instruction for deleting a character.

120. The storage medium of claim 100 wherein the device is used to focus electronically on selectable items of World Wide Web pages or other application documents or forms using at least one of said one or more displays and has a Tab-Forward button located as a side-key or located as a face-key, wherein in response to a user depressing said Tab-Forward button the computer implemented process generates one or more codes that are interpreted as an instruction for quickly moving the focus from a first selectable item on the page, document or form to the next selectable item on the page, document or form.

121. The storage medium of claim 120 wherein the device has a Tab-Backward button located as a side-key or as a face-key, and wherein in response to a user depressing said Tab-Backward button the computer implemented process generates one or more codes interpreted as an instruction for quickly moving the focus from a first selectable item on the page, document or form to the previous selectable item on the page, document or form.

122. The storage medium of claim 120 wherein the device has a Select button located as a side-key or as a face-key, and wherein in response to a user depressing said Select button the computer implemented process generates one or more codes that are interpreted as an instruction for selecting the item currently in focus.

123. The storage medium of claim 120 wherein the device has a thumb wheel located on the side of said device and wherein (1) in response to a user rolling said thumb wheel in one direction with a thumb or other finger the computer implemented process generates codes interpreted as instructions for tabbing forward among said selectable items, and (2) in response to a user rolling said thumb wheel in the other direction with a thumb or other finger the computer implemented process generates codes interpreted as instructions for tabbing backward among said selectable items.

124. The storage medium of claim 123 wherein in response to the user depressing the thumb wheel the computer implemented process generates one or more codes interpreted as an instruction to select the item currently in focus.

125. A storage medium having embedded therein a computer implanted process for interpreting keystrokes on a hand-held electronic device having a plurality of face-keys, one or more displays, and one or more modifier buttons located on the face of said device or on one or both sides of said device, wherein a user types or invokes a function by depressing one of the face-keys while simultaneously depressing none, one or combinations of the modifier buttons;
wherein a plurality of the keys each has a number of graphical strokes associated with and,
(a) in response to a user depressing solely one of said plurality of face-keys the computer implemented process generates a first code interpreted as an instruction to generate a predetermined one of the graphical strokes,
(b) in response to a user depressing said one key while depressing one modifier key the computer implemented process generates a second code interpreted as an instruction to generate a second predetermined one of the graphical strokes, and
(c) in response to a user depressing said one key while depressing a second modifier key the computer implemented process generates a third code interpreted as an instruction to generate a third predetermined one of the graphical strokes.

126. The storage medium of claim 125 wherein the device has a Shift button and wherein in response to a user concurrently depressing the Shift button and a particular face-key and a particular combination of said modifier buttons the computer implemented process generates one or more codes interpreted as an instruction to generate a graphical stroke or function that is different than the stroke or function that is generated when said particular face-key and said combination of modifier buttons are concurrently depressed without said Shift button being depressed.

127. The storage medium of claim 125 wherein the computer implemented process generates one or more codes interpreted as an instruction to cause the graphical strokes to form a character or a graphical figure from said graphical strokes for display on said display.

128. The device of claim 1 or claim 19 or claim 51 wherein the character typed or the stroke typed or the function invoked for any given combination of face-keys and side modifier buttons depressed or operated concurrently can vary depending on software context.

129. The computer implemented process of claim 59 or claim 65 or claim 91 wherein the interpretation of keystrokes and button presses can vary depending on software context.

130. The storage medium of claim 94 or claim 100 or claim 125 wherein the interpretation of keystrokes and button presses can vary depending on software context.

131. The device of claim 19 wherein the device is a cell phone that further includes (1) a multi-key-presses-per-letter typing mode primarily operated with one hand and (2) an interface that allows users to switch between said typing mode and a typing mode operated by depressing of one of the face-keys while simultaneously depressing none of, one of, or a combination of the one or more modifier buttons.

132. A hand-held electronic device including at least one face-key and including one or more modifier buttons on one side or both sides of the device, wherein a user of said device can hold the device with on hand and type a symbol or invoke a function by depressing one of the at least one face-keys using a finger on the hand that is not holding the device while concurrently depressing none of, one of, or a combination of the one or more modifier buttons with fingers on the hand that is holding the device.

133. The device of claim 132 wherein symbols that can be typed include characters, strokes, entire words, and images.
